(19) United States
(12) Patent Application Publication
(10) Pub. No.: US 2009/0250670 A1
(43) Pub. Date: Oct. 8, 2009

(54) PHOTOCHROMIC FILMS AND METHOD FOR MANUFACTURING THE SAME

(75) Inventors: Sang Young Kim, Gyeonggi-do (KR); Deuk Ho Lee, Chungcheongnam-do (KR); Woo Sung Kim, Daejeon (KR)

Correspondence Address: EDWARDS ANGELL PALMER & DODGE LLP, P.O. BOX 55874, BOSTON, MA, 02205, US

(73) Assignees: Hyundai Motor Company, Seoul (KR); LG Chem Ltd., Seoul (KR); KOREA AUTOGLASS, Chungcheonnam-Do (KR)

(21) Appl. No.: 12/276,921

(22) Filed: Nov. 24, 2008

(30) Foreign Application Priority Data
Apr. 3, 2008 (KR) 10-2008-0031353

(51) Int. Cl. G02B 5/23

(52) U.S. Cl. 252/586

(57) ABSTRACT

Disclosed is a photochromic film for automobiles prepared by curing a photochromic composition comprising an acrylic resin, a crosslinking agent having an intramolecular UV stabilizing structure, and a photochromic dye, a preparation method of the photochromic film for automobiles, and an article comprising the photochromic film for automobiles.

### CROSS-REFERENCE TO RELATED APPLICATION

This application claims under 35 U.S.C. §119(a) the benefit of Korean Patent Application No. 10-2008-0031353 filed Apr. 3, 2008, the entire contents of which are incorporated herein by reference.

### BACKGROUND

1. Technical Field

The present invention relates to a photochromic film and a method for preparing the same. More particularly, the present invention relates to a photochromic film for automobiles with superior transparency and weather resistance and a method for preparing the same.

2. Background Art

In general, colored films are coated or glasses on which metallic components are vacuum deposited. Colored films are frequently used in articles which transmit light and are exposed to direct sunlight for a long time, such as windows of vehicles, in order to partly block the light. However, since a predetermined portion of visible light is always without regard to the intensity of light, the user may experience dark vision in the nighttime or on a cloudy day.

Photochromism was discovered more than 100 years ago, and since then there have been various attempts to utilize photochromic materials for commercial purposes. In particular, with the recent development of photochromic lenses for eyeglasses by Corning Incorporated (USA), research on commercially available control of light transmittance with good transparency and color emission is actively being pursued. Accordingly, photochromic films are an example.

Existing photochromic film products are mostly films prepared by extrusion molding a master batch of resins such as, but not limited to, polyethylene, polypropylene, polystyrene, ABS, and the like. Because of poor transparency, these films are mostly used in applications where good transparency is not required, such as agricultural films. However, these films cannot be used as photochromic films for automobiles, where good vision is required.

Korean Patent Publication No. 2003-0089544 discloses a photochromic film prepared by using a PET (polyethylene terephthalate) film as base film and coating a photochromic acrylic adhesive on the film with an adequate thickness for use as window tinting film. The photochromic film prepared by this method is damaged easily because of poor weather resistance.

The above information disclosed in this the Background section is only for enhancement of understanding of the background of the invention and therefore it may contain information that does not form the prior art that is already known in this country to a person of ordinary skill in the art.

### SUMMARY

In one aspect, the present invention provides a photochromic composition having superior transparency and weather resistance as to be applicable to windows of automobiles, a photochromic film comprising the same, a method for preparing the same, and a transparent article for automobiles comprising the photochromic film.

Accordingly, the invention provides in preferred embodiments a photochromic film which is formed by suitably curing a photochromic composition preferably comprising an acrylic resin, a crosslinking agent having an intramolecular UV stabilizing structure, and a photochromic dye.

In accordance with another preferred embodiment of the present invention, there is provided a preparation method of a photochromic film preferably comprising the steps of: injecting a photochromic composition suitably comprising an acrylic resin, a crosslinking agent having an intramolecular UV stabilizing structure, and a photochromic dye in the space formed by a gasket suitably provided between a pair of substrate; and curing the photochromic composition.

In accordance with another embodiment of the present invention, there is provided a transparent article for automobiles suitably comprising a transparent substrate and the aforesaid photochromic film, preferably provided at least on one side of the transparent substrate.

The photochromic film for automobiles according to the present invention which, in certain preferred embodiments, is prepared by curing a photochromic composition comprising an acrylic resin, a crosslinking agent having a particular structure, and a photochromic dye provides considerable and superior transparency and weather resistance.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated by the accompanying drawings which are given hereinafter by way of illustration only, and thus are not limitative of the present invention, and wherein:

FIG. 1 is a cross-sectional view of an article comprising the photochromic film of the present invention; and

FIG. 2 is a cross-sectional view of an article comprising the photochromic film of the present invention and an adhesion layer.

### DETAILED DESCRIPTION

As described herein, the present invention includes a photochromic composition comprising an acrylic resin, at least one crosslinking agent; and a photochromic dye.

In one embodiment of the invention, the photochromic composition preferably comprises 65-99 weight % of an acrylic resin, 0.01-30 weight % of at least one crosslinking agent, and 0.01-5 weight % of a photochromic dye. In related embodiments, the at least one crosslinking agent is selected from the group consisting of, but not limited to, benzophenones, acetophenones, anthraquinones, monoethylenic unsaturated aromatic ketones, acrylamido functional disubstituted acetyl aryl ketones, substituted triazines, piperidines, methoxysilanes, ethoxysilanes, oxysilanes, alkoxysilanes, acrylamides, acrylamidoglycolic acids and aziridines.

In another aspect, the invention features a preparation method of a photochromic film for automobiles comprising the steps of injecting a photochromic composition comprising an acrylic resin, a crosslinking agent and a photochromic dye in the space formed by a gasket provided between a pair of substrate.

In one embodiment of the preparation methods, the photochromic composition comprises 65-99 weight % of the acrylic resin, 0.01-30 weight % of the crosslinking agent and 0.01-5 weight % of the photochromic dye.

In another embodiment of the preparation method, the method further comprises curing the photochromic composition.

The invention can also include a motor vehicle comprising the photochromic composition of claim 1.

Reference will now be made in detail to the preferred embodiments of the present invention.

The photochromic composition according to the present invention preferably comprises, but may not only be limited to, an acrylic resin, a crosslinking agent having a suitable intramolecular UV stabilizing structure, and a photochromic dye.

As used herein, the term acrylic resin is meant to refer to an acrylic fiber. Preferably, acrylic fibers are made from a homopolymer of acrylonitrile (CH₂═CHCN) or a copolymer with other comonomers (acetylene+cyanate). Suitably based on the content of acrylonitrile, the fibers are classified into acrylic fibers (≧85%) and modacrylic fibers (35-85%). In preferred embodiments, acrylic fibers are synthetic fibers made from a linear synthetic polymer comprising acrylonitrile, and capably of forming fibers. In preferred embodiments, the acrylic fibers comprise 85% or more acrylonitrile and are capable of forming fibers. Acrylonitrile was synthesized in the late 1890s, and it was soon known that it may be preferably prepared by polymerization. When suitably heated, this polymer is decomposed before being melted and thus there was no adequate solvent. It was found that acrylonitrile can be preferably used as mixed with a synthetic rubber. A solvent was developed that can dissolve a polymer of the compound. Commercialization started when, in 1945, DuPont developed a solvent that can dissolve a polymer of the compound. In 1950, it was commercialized in the brand name Orion. In 1952, it was produced in the brand name Acrilan by Monsanto.

Originally, acrylic was developed in the light of optoelectricity, convenience of manufacture, convenience of processing, and lightweightness. Acrylic has both the properties of the convenience of plastics and the cleanness of glass. It is also vulnerable to fire and less transparent than glass. Acrylic has a specific gravity of 1.17-1.20, which is about ½ that of inorganic glass. Accordingly, a larger specific gravity has better mechanical and physical properties. Acrylic has such excellent transparency as to transmit 92-98% of light. In the UV region, it shows granularity at around 2,500 Å and begins to transmit UV rays. In general, it exhibits outstanding UV transmittance as compared with inorganic glass.

In preferred embodiments of the present invention, the acrylic resin may preferably be a compound having a suitable esteric carbonyl group and a suitable conjugated carbon-carbon double bond, and substituents are not particularly limited. Both acrylic monomers and polymers comprising the monomers as polymerization units are included. The acrylic monomer preferably includes not only acrylates but also acrylate derivatives. For example, but not only limited to, alkyl acrylate, alkyl methacrylate, alkyl butacrylate, and so forth are included in the invention described herein.

In preferred embodiments, the acrylic monomer may be at least one selected from the group consisting of, but not limited to, methyl acrylate, ethyl acrylate, methyl methacrylate, ethyl methacrylate, methyl ethacrylate, ethyl ethacrylate, hydroxyethyl acrylate, hydroxyethyl methacrylate, hydroxypropyl acrylate and hydroxypropyl methacrylate. In particular embodiments, methyl methacrylate (MMA) is the most preferable to be used. In further embodiments, the polymer comprising the acrylic monomer as a polymerization unit may further comprise an ethylenic unsaturated monomer copolymerizable with the acrylic monomer. The acrylic resin may be comprised in an amount of 50, 55, 60, 65, 70, 75, 80, 85, 90, 95, 96, 97, 98, 99 weight %. In preferred embodiments, the acrylic resin is comprised in an amount of 65-99 weight %.

In accordance with certain embodiments of the present invention, transparency and weather resistance of the film can be considerably improved by using a crosslinking agent having a suitable intramolecular UV stabilizing structure in the photochromic composition.

Energy required for a chemical reaction can be provided not only by heat but also by light. UV with a wavelength of 3400 Å or shorter has sufficient energy enough to suitably decompose some molecules. Plastics tend to become discolored and brittle by UV with a wavelength of 3000 to 3400 Å of sunlight. Accordingly, UV stabilizers are added to protect the plastics by blocking or absorbing the UV radiation. UV stabilizers are classified into absorbents, quenchers and hindered amine light stabilizers (HALS), depending on their functioning mechanisms. Also, they may be classified into phenyl salicylate (absorbent), benzophenone (absorbent), benzotriazole (absorbent), nickel derivatives (quenchers) and radical scavengers, depending on their chemical structures.

In embodiments of the present invention, the crosslinking agent is not particularly restricted as long as it has a suitable intramolecular structure derived from the UV stabilizers.

In further embodiments, the crosslinking agent may be at least one selected from the group consisting of, but not only limited to, benzophenones, acetophenones, anthraquinones, monoethylenic unsaturated aromatic ketones, acrylamido functional disubstituted acetyl aryl ketones, substituted triazines, piperidines, methoxysilanes, ethoxysilanes, oxysilanes, alkoxysilanes, acrylamides, acrylamidoglycolic acids and aziridines.

In further embodiments, specific examples of the crosslinking agent include, but are not limited to, crosslinking agents based on benzophenone, acetophenone, and anthraquinone; monoethylenic unsaturated aromatic ketones, e.g., 4-acryloxybenzophenone (ABP) and P,P′-bis(acryloyloxy)benzophenone; acrylamido functional disubstituted acetyl aryl ketones; substituted triazines, e.g., 2,4-bis(trichloromethyl)-6-p-methoxystyrene-5-triazine, chromophore halomethyl-5-triazine and 1,3,5-triacroylamino-hexahydro-s-triazine; monoethylenic unsaturated mono-, di- and trialkoxy silane compounds, e.g., 1-methacryloyl-4-methacryloylamino-2,2,6,6-tetramethylpiperidine, methacryloxypropyltrimethoxysilane, vinyldimethylethoxysilane, vinylethyldiethoxysilane, vinyltriethoxysilane, vinyltrimethoxysilane and vinyltriphenoxysilane; acrylamides, e.g., N-methylolacrylamide and bisamide; acrylamidoglycolic acids; and aziridines. In more particular embodiments, HALS is preferred as the crosslinking agent.

Preferably, the crosslinking agent is included in an amount of 0.005, 0.001, 0.05, 0.1, 0.5, 1, 3, 5, 7, 9, 11, 15, 17, 19, 21, 25, 26, 27, 28, 29, 30 weight %. In further preferred embodiments, the crosslinking agent is included in an amount of 0.01-30 weight %. Preferably, when the addition amount is larger than 30%, that is when the resin is preferably used in an amount less than 65%, the film may suitably shrink and become brittle due to insufficient flexibility.

A photochromic material refers to a material that undergoes a suitable color change upon exposure to light, and may be classified into inorganic compounds and organic synthetic compounds. Photochromic materials are also referred to as photochromics. Examples of inorganic photochromics include, but are not limited to, TiO₂, ZnS, etc., and those of organic photochromics include, but are not limited to, oxazines, naphthopyrans, benzos, spiropyrans, etc. Frequently used photochromics, for example frequently used organic photochromics include, oxazines and spiropyrans are frequently used.

In embodiments of the present invention, any photochromic dye as known to those skilled in the art is suitable to be used as the photochromic dye. For example, but not only limited to, spiro-oxazine based organic compound or naphthopyran based organic compounds, are examples of dyes that may be used. As used in embodiments herein, a compound having a specific chemical structure preferably refers to a compound having the chemical structure suitably as a core structure, and in certain embodiments suitably includes the compounds consisting of the chemical structure only and their derivatives. In embodiments of the invention, the photochromic dye may be used in an amount of 0.01-5 weight %, preferably 0.1-3 weight %. In examples when the dye is used in an amount less than 0.01%, color fastness may be suitably low due to decreased optical density. In other examples, when the dye is used in an amount suitably exceeding 5%, beyond the saturation of optical density, the dye may not be suitably soluble.

In preferred embodiments, the photochromic composition for forming a photochromic film for automobiles according to the present invention may further preferably include additives known to those skilled in the art, suitably within the ranges not affecting the intended properties. Examples include, but are not limited to, polymerization initiator, stabilizer, UV absorbent, antioxidant, chain transfer agent, IR absorbent, antifoaming agent, antistatic, releasing agent, and the like may be added. Preferably, each of these additives may be added in an amount of 0.01-5 weight %. In other further embodiments, in order to suitably provide initial color, common dyes with various colors may be used in an amount of 0.0001-0.5 weight % either alone or in combination.

Preferably, the photochromic film for automobiles according to the present invention is 1 to 200 mm thick.

In preferred embodiments, the photochromic film for automobiles according to the present invention has a weather resistance of at least 1,000 hours and can be suitably used, for example, in windows of automobiles. As used herein, weather resistance is meant to refer to the time spent until the transmittance upon initial discoloration at λₘᵢₙ (the wavelength at which the transmittance is lowest) increases by half. Accordingly, in exemplary embodiments, provided that the transmittance upon initial discoloration before weather resistance test was 10%, the time spent until the transmittance increases, for example, to 55% during the weather resistance, and is suitably defined as the weather resistance. Preferably, the weather resistance may be determined by subjecting the sample to the ASTM G 154-99 cycle of radiation at 340 nm with an intensity of 0.77 W/m² under the condition of 60° C. for 8 hours followed by condensation at 50° C. for 4 hours, using an accelerated weather resistance apparatus ATLAS UV 2000 and a UVA fluorescence lamp, to suitably measure the optical density.

In another preferred embodiment of the present invention, the photochromic film for automobiles according to the present invention may be suitably inserted between a pair of transparent substrates. The photochromic film for automobiles according to the present invention may be suitably adhered to the transparent substrates using an adhesion layer. In other embodiments, the photochromic composition may be directly coated on the transparent substrate to suitably form the photochromic film. Alternatively, the photochromic composition may be preferably filled between a pair of transparent substrates, and heat and pressure may be suitably applied to form the photochromic film between the pair of transparent substrates.

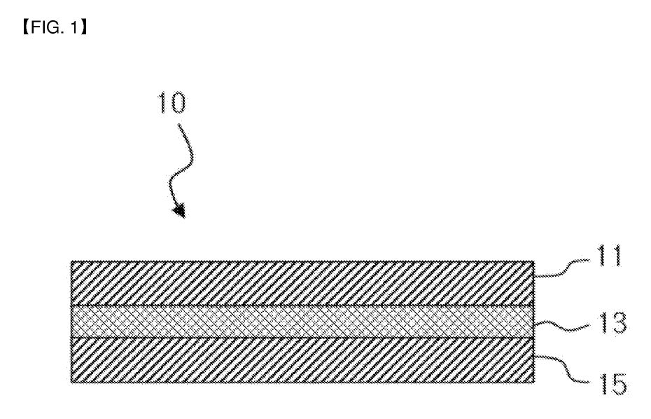

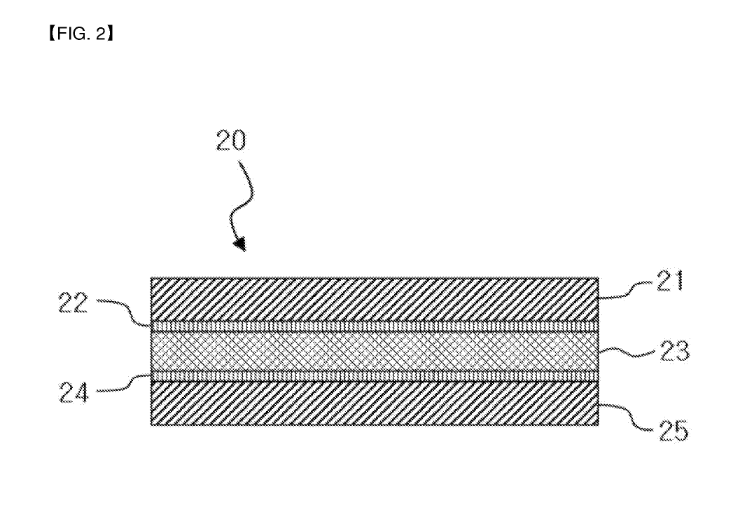

Preferably, the transparent substrate may be a glass substrate or a plastic substrate, and the glass may preferably be, but not limited to, safety glass or tempered glass. FIG. 1 is a cross-sectional view of an exemplary article comprising the photochromic film of the present invention. The article 10 shown in FIG. 1 comprises a pair of transparent substrates 11, 15 between which the photochromic film 13 according to the present invention is suitably inserted. FIG. 2 is a cross-sectional view of an article 20 suitably comprising a pair of transparent substrates 21, 25 and a photochromic film 23 preferably interposed therebetween as suitably adhered by adhesion layers 22, 24.

In other preferred embodiments, the present invention further provides a preparation method of the aforesaid photochromic film suitably for automobiles. In further embodiments, the present invention provides a preparation method of a preferred photochromic film for automobiles comprising the steps of: suitably injecting the aforesaid photochromic composition comprising an acrylic resin, a crosslinking agent and a photochromic dye in the space formed by a gasket provided between a pair of substrate; and preferably curing the photochromic composition.

In embodiments of the present invention, the gasket material is not particularly limited, as long as it is not suitably dissolved by the photochromic composition. Preferably, the inside of the gasket may be either hollow or filled. In further embodiments, the cross-section may be, but is not limited to, circle, rectangle, trapezoid, and so forth, and the gasket may have a suitable conical shape. Those skilled in the art may determine the thickness of the gasket considering the wanted film thickness. Also, the gasket size may be suitably determined considering the wanted film size.

In the present invention, the substrate material is not particularly limited, but any one known to those skilled in the art may be suitably used without restriction. For example, although not limited to, glass, metal or plastic substrate may be suitably used. In certain embodiments, glass is the most preferred. In other embodiments, the substrate surface may be flat, but it may be suitably curved if necessary.

According to other embodiments, an adhesion sheet may be suitably provided between the gasket and the substrate in order to adhere the gasket to the substrate. In further embodiments, a sealing film may be preferably used to suitably seal the gasket and the substrate.

In other embodiments, the preparation method according to the present invention may further comprise the step of separating the substrate and the gasket, after curing, and removing the acrylic film.

The following examples further illustrate the present invention, with the scope of the present invention not limited by the examples herein.

### EXAMPLE

### Preparation of Photochromic Film Comprising Crosslinking Agent

A photochromic composition was suitably prepared by mixing the components described in the following Table 1.

TABLE 1

| Components | Compounds | Contents |
|---|---|---|
| Monomer and | BP4PA (Kyosei) | 40 g |
| crosslinking agent | MMA (methyl methacrylate) | 20 g |
| | HEMA (hydroxyethyl | 20 g |
| | methacrylate) | |
| | P,P′-bis(acryloyloxy)benzophenone | 20 g |
| Polymerization initiator | V-65 (Waco) | 0.2 g |
| Dye | Palatinate purple (James Robinson) | 1 g |
| Stabilizer | HALS (Tinuvin 144, Ciba) | 1 g |

| | |
|---|---|
| Total | 102.2 g |

A photochromic film was suitably prepared using the photochromic composition comprising the components as described in Table 1. In exemplary embodiments, a pair of 2 mm-thick glass plates were spaced by 300 μm preferably using a spacer. The photochromic composition was filled between the glass plates and heat cured for 6 hours to suitably obtain a 300 μm-thick film. In other exemplary embodiments, the curing was carried out under normal pressure, by gradually increasing temperature from 25° C. to 100° C. over a 4-hour period, maintaining at 100° C. for 2 hours, and then lowering temperature back to 25° C. over a 4-hour period.

Initial transmittance of the prepared film was suitably 70% and optical density was below 30%. In further exemplary embodiments, weather resistance was 1200 hours.

### COMPARATIVE EXAMPLE

### Preparation of Photochromic Film

A photochromic composition was prepared by mixing the components described in the following Table 2.

TABLE 2

| Components | Compounds | Contents |
|---|---|---|
| Monomer | BP4PA (Kyosei) | 40 g |
| | MMA | 20 g |
| | HEMA | 20 g |
| | HDDA (hexanediol diacrylate) | 20 g |
| Polymerization initiator | V-65 (Waco) | 0.2 g |
| Dye | Palatinate purple (James Robinson) | 1 g |
| Stabilizer | HALS (Tinuvin 144, Ciba) | 1 g |

| | |
|---|---|
| Total | 102.2 g |

According to further embodiments, a photochromic film was prepared in the same manner as in Example using the photochromic composition comprising the components as described in Table 2. Initial transmittance of the prepared film was 70% and optical density was 20%. Weather resistance was 1000 hours.

As described in the Example and Comparative Example herein, weather resistance of the Example is suitably better than Comparative Example by 20%. Accordingly, the addition of the crosslinking agent provides considerably improved weather resistance, without suitably affecting transparency.

Although the preferred embodiments of the present invention have been disclosed for illustrative purposes, those skilled in the art will appreciate that various modifications, additions and substitutions are possible, without departing from the spirit and scope of the invention as disclosed in the accompanying claims.

What is claimed is:

1. A photochromic composition comprising:
65-99 weight % of an acrylic resin;
0.01-30 weight % of at least one crosslinking agent selected from the group consisting of benzophenones, acetophenones, anthraquinones, monoethylenic unsaturated aromatic ketones, acrylamido functional disubstituted acetyl aryl ketones, substituted triazines, piperidines, methoxysilanes, ethoxysilanes, oxysilanes, alkoxysilanes, acrylamides, acrylamidoglycolic acids and aziridines; and
0.01-5 weight % of a photochromic dye.

2. The photochromic composition according to claim 1, wherein the crosslinking agent is at least one selected from the group consisting of: benzophenones, acetophenones, anthraquinones, monoethylenic unsaturated aromatic ketones, 4-acryloxybenzophenone (ABP), P,P′-bis(acryloyloxy)benzophenone, acrylamido functional disubstituted acetyl aryl ketones, substituted triazines, 2,4-bis(trichloromethyl)-6-p-methoxystyrene-5-triazine, chromophore halomethyl-5-triazine, 1,3,5-triacroylamino-hexahydro-s-triazine, monoethylenic unsaturated mono-, di- and trialkoxy silane compounds, 1-methacryloyl-4-methacryloylamino-2,2,6,6-tetramethylpiperidine, methacryloxypropyltrimethoxysilane, vinyldimethylethoxysilane, vinylmethyldiethoxysilane, vinyltriethoxysilane, vinyltrimethoxysilane, vinyltriphenoxysilane; acrylamides, N-methylolacrylamide; acrylamidoglycolic acids, and aziridines.

3. The photochromic composition according to claim 1, wherein the crosslinking agent is a hindered amine light stabilizer (HALS).

4. The photochromic composition according to claim 1, wherein the photochromic dye is a spiro-oxazine based organic compound or a naphthopyran based organic compound.

5. A preparation method of a photochromic film for automobiles comprising the steps of:
injecting a photochromic composition comprising 65-99 weight % of an acrylic resin, 0.01-30 weight % of a crosslinking agent and 0.01-5 weight % of a photochromic dye in the space formed by a gasket provided between a pair of substrate; and
curing the photochromic composition.

6. The preparation method of a photochromic film for automobiles according to claim 5, further comprising the step of separating the substrate and the gasket, after curing, and removing the acrylic film.

7. A photochromic composition comprising:
an acrylic resin;
at least one crosslinking agent; and
a photochromic dye.

8. The photochromic composition of claim 7, wherein the composition comprises 65-99 weight % of an acrylic resin;
0.01-30 weight % of at least one crosslinking agent; and
0.01-5 weight % of a photochromic dye.

9. The photochromic composition of claim 7, wherein the at least one crosslinking agent is selected from the group consisting of: benzophenones, acetophenones, anthraquinones, monoethylenic unsaturated aromatic ketones, acrylamido functional disubstituted acetyl aryl ketones, substituted triazines, piperidines, methoxysilanes, ethoxysilanes, oxysilanes, alkoxysilanes, acrylamides, acrylamidoglycolic acids and aziridines.

10. A preparation method of a photochromic film for automobiles comprising the steps of:
injecting a photochromic composition comprising an acrylic resin, a crosslinking agent and a photochromic dye in the space formed by a gasket provided between a pair of substrate.

11. The preparation method of a photochromic film for automobiles of claim 10, wherein the photochromic composition comprises 65-99 weight % of the acrylic resin, 0.01-30 weight % of the crosslinking agent and 0.01-5 weight % of the photochromic dye.

12. The preparation method of a photochromic film for automobiles of claim 10, wherein the method further comprises curing the photochromic composition.

13. A motor vehicle comprising the photochromic composition of claim 1.

14. A motor vehicle comprising the photochromic composition of claim 7.
